(19) United States
(12) Patent Application Publication
(10) Pub. No.: US 2014/0325685 A1
(43) Pub. Date: Oct. 30, 2014

(54) METHOD FOR CONTROLLING ACCESS TO DATA AND ELECTRONIC DEVICE THEREOF

(71) Applicant: Samsung Electronics Co., Ltd., Gyeonggi-do (KR)

(72) Inventors: Seung-Min HA, Jeollabuk-do (KR); Beom-Jun LEE, Gyeonggi-do (KR)

(73) Assignee: Samsung Electronics Co., Ltd., Gyeonggi-do (KR)

(21) Appl. No.: 14/249,775

(22) Filed: Apr. 10, 2014

(30) Foreign Application Priority Data
Apr. 30, 2013 (KR) 10-2013-0048254

(51) Int. Cl. G06F 21/10

(52) U.S. Cl. CPC G06F 21/10
USPC 726/30

(57) ABSTRACT

A system determines access authorization to data in an electronic device by detecting application identifier information of an application program and detecting manufacturer identifier information of the application program. The system generates access token information using the application identifier information of the application program and the manufacturer identifier information.

### CLAIM OF PRIORITY

This application claims priority under 35 U.S.C. §119 to an application filed in the Korean Intellectual Property Office on Apr. 30, 2013 and assigned Serial No. 10-2013-0048254, the contents of which are incorporated herein by reference.

### BACKGROUND

1. Technical Field

The present system concerns controlling access to data in an electronic device.

2. Description of the Related Art

Portable terminals provide various services including voice and video call functions, an information input/output function, and a data transmission/reception function. Executable application programs commonly refer to the data of another executable application program or initiate an internal operation of another application program. In known systems, when an application program is installed as illustrated in FIG. 3, an electronic device displays guide for information facilitating user installation of the application program. For example, the electronic device performs a process of asking a user to agree with access to a stored address book or photo album. In this case, the user typically selects an [OK] button to carry out installation of the application program. In addition, it may be necessary to include information (acceptance information) of an application program's manufacturer in an application program package. Also, another program including the information of a manufacturer identical to the application program's manufacturer may access data or functions without a separate authentication process. These requirements add complexity to application data access. Therefore, there is a need for a method for controlling data access of an application program in an electronic device.

### SUMMARY

A system generates access token information to control data access of an application program in an electronic device, controls an application program that requests access to data in an electronic device and controls data access of an application program using access token information in an electronic device.

A system determines access authorization to data in an electronic device by detecting application identifier information of an application program and detecting manufacturer identifier information of the application program. The system generates access token information using the application identifier information of the application program and the manufacturer identifier information.

In a feature, the system applies a message digest process to the manufacturer identifier information in response to detection of the application identifier information of the application program and the manufacturer identifier information to derive the access token information and the manufacturer comprises at least one of, (a) an owner, (b) beneficiary and (c) provider, of the application program source code. The system generates access token information using the application identifier information of the application program and the manufacturer identifier information derived using the message digest algorithm. Also the system generates a character string by sequentially appending the application identifier information of the application program and the manufacturer identifier information in response to detection of the application identifier information of the application program and the manufacturer identifier information. Access token information is generated by encrypting the character string and encrypting the character string using an asymmetric encryption key. The application program is packaged to include the application identifier information, the manufacturer identifier information and the access token information.

In another feature, a method controls access to data in an electronic device, by in response to generation of a request for data access by an application program, detecting application identifier information of the application program, manufacturer identifier information, and first access token information. A first character string is generated using the application identifier information of the application program and the manufacturer identifier information and a second character string is generated by decrypting the first access token information. In response to a determination the first character string is identical to the second character string, authorizing the application program to access data.

In another feature an electronic device, comprises at least one processor; at least one memory; and at least one program stored in the memory and configured to be executable by the processor. The processor detects application identifier information of an application program and manufacturer identifier information and generates access token information using application identifier information of the application program and the manufacturer identifier information. The processor, in response to a request for data access being generated by an application program, detects application identifier information of the application program, manufacturer identifier information, and first access token information; generates a first character string using the application identifier information of the application program and the manufacturer identifier information; generates a second character string by decrypting the first access token information; and in response to the first character string being identical to the second character string, authorizing the application program to access data.

### BRIEF DESCRIPTION OF THE DRAWINGS

The above features and advantages of the present disclosure will become more apparent from the following detailed description when taken in conjunction with the accompanying drawings in which:

FIG. 1 shows an electronic device according to disclosure principles;

FIG. 2 shows a processor according to disclosure principles;

FIG. 3 shows a known type of installation menu;

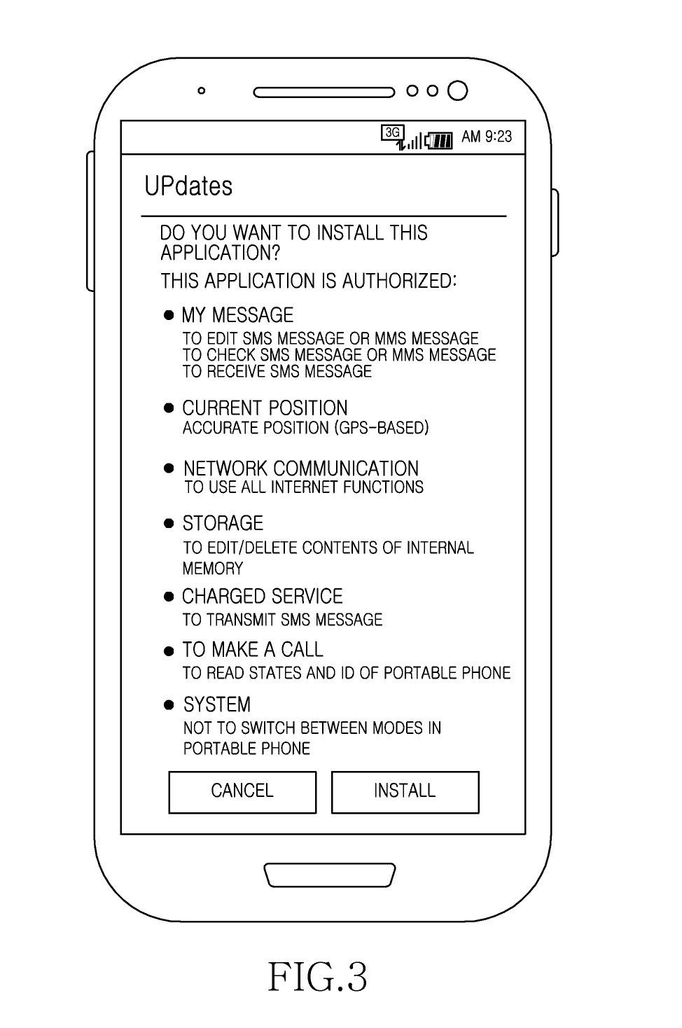

FIG. 4A shows a flowchart of a process for generating access token information to control data access of an application program in an electronic device according to disclosure principles;

FIG. 4B shows an electronic device for generating access token information to control data access of an application program according to disclosure principles;

FIG. 5 shows a flowchart of a process for generating access token information to control data access of an application program in an electronic device according to disclosure principles;

FIG. 6A shows a flowchart of a process for controlling data access of an application program in an electronic device according to disclosure principles;

FIG. 6B shows an electronic device for controlling data access of an application program according to disclosure principles; and

FIG. 7 shows a flowchart of a process for controlling data access of an application program in an electronic device according to disclosure principles.

### DETAILED DESCRIPTION

Exemplary embodiments of a system are described with reference to the accompanying drawings. In the following description of the exemplary embodiments, detailed descriptions of well-known functions or configurations will be omitted since they would unnecessarily obscure the subject matters of the present disclosure. Also, the terms used herein are defined according to the functions of the system. The system controls access to data in an electronic device and controls an application program that accesses data or a function in an electronic device. In the following description, examples of the electronic device may include a personal digital assistant (PDA), a laptop computer, a smart phone, a netbook, a television, a mobile internet device (MID), an ultra mobile personal computer (UMPC), a tablet PC, a navigation device, a digital refrigerator, a digital watch, and an MP3 player.

An application program as used herein includes application identifier information and manufacturer identifier information. The application identifier information comprises identifiers for distinguishing between respective application programs of a plurality of application programs in the electronic device. An application program may include application identifier information. and application manufacturer identifier (sign) information identifying a manufacturer that develops the application program. Manufacturer identifier information may be associated with a plurality of application programs. It has been known for application programs to be illegally modified. A system generates access token information using the application identifier information and manufacturer identifier information of an initial application program and includes the access token information in the application program. When a request for access to data is generated by an application program, an electronic device may determine whether the application program is changed using the application identifier information, the manufacturer identifier information, and the access token information after the generation of the access token information. A manufacturer as used herein may comprise an ultimate owner, beneficiary or source of the application program source code. In another embodiment the manufacturer identifier may comprise a lessor, renter, reseller or intermediary party between the provider of the application program and the retail buyer, lessor, renter and ultimate user of the application program.

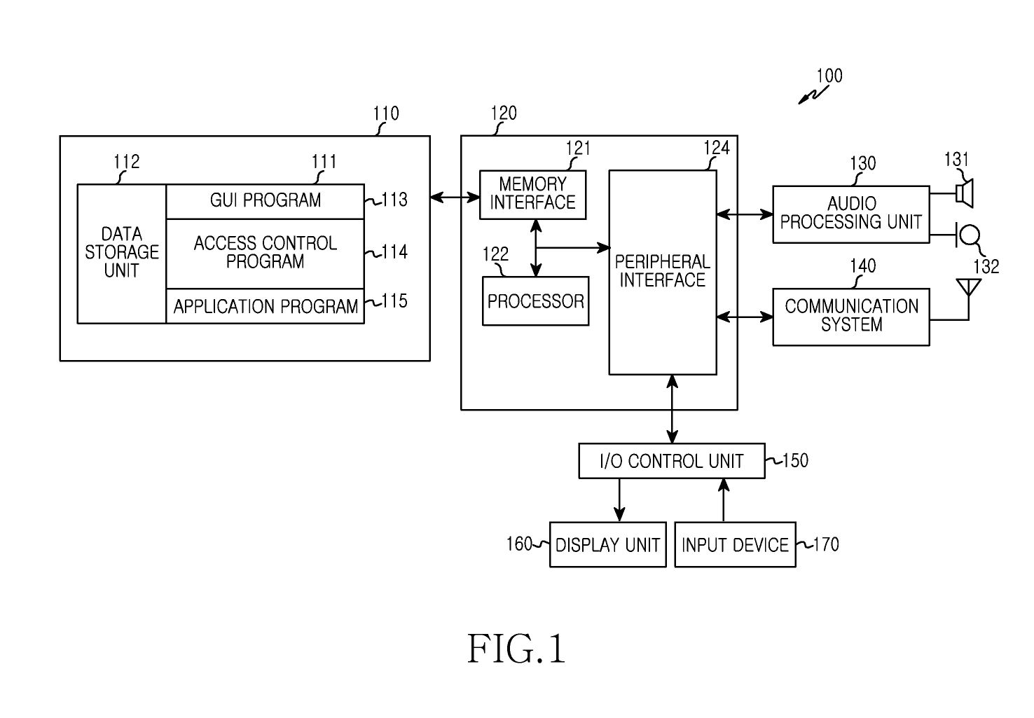

FIG. 1 shows an electronic device 100 including a memory 110, a processor unit 120, an audio processing unit 130, a communication system 140, an input/output (I/O) control unit 150, a display unit 160, and an input device 170. The memory 110 may be a plurality of devices. The memory 110 may include a program storage unit 111 for storing a program for controlling an operation of the electronic device 100 and a data storage unit 112 for storing data generated during the execution of a program. The program storage unit 111 may include a Graphic User Interface (GUI) program 113, an access control program 114 and at least one application program 115. The program stored in the program storage unit 111 may be expressed as an instruction set comprising a collection of instructions. The GUI program 113 may include at least one software component for providing a graphic user interface on the display unit 160. For example, the GUI program 113 performs control to display information about an application program executed by the processor 122 on the display unit 160. The GUI program 113 may enable the access control program 114 to display a message indicating whether it is possible to access the data of the electronic device 100 on the display unit 160.

The access control program 114 may include at least one software component for generating access token information in order to control data access of an application program. For example, the access control unit 114 detects the application identifier information and manufacturer identifier information of an application program for enabling access to the data of the electronic device. The application identifier information of the application program denotes identifiers for distinguishing between respective application programs of a plurality of application programs in the electronic device. An application program may include an item of application identifier information. In addition, the manufacturer identifier information of the application program refers to information of a manufacturer that develops the application program. An item of manufacturer identifier information may be included in a plurality of application programs. Access control program 114 applies a message digest algorithm to the manufacturer identifier information. In this case, the message digest algorithm generates a fixed length of output character string regardless of the length of an original character string. The message digest algorithm may employ at least one of MD2 (Message Digest 2), MD4 (Message Digest 4), MD5 (Message Digest 5), SHA (Secure Hash Algorithm), and SHA1 (Secure Hash Algorithm 1). Thereafter, the access control program 114 generates a character string by using the application identifier information and the manufacturer identifier information by processing with the message digest algorithm. Thereafter, the access control program 114 generates access token information by encrypting the character string using an asymmetric encryption key.

The access control program 114 may include at least one software component for controlling data access of an application program. For example, when at least one application program performs an attempt to access data (for example, call log, message contents, and Internet bookmark information) stored in the electronic device and functions (for example, message transmission function, telephone function, and network connection function), the access control program 114 detects the application identifier information, manufacturer identifier information, and access token information of the application program. Access control program 114 applies a message digest algorithm to the manufacturer identifier information. Access control program 114 generates a first character string by sequentially joining a character string including the application identifier information and the character string of the manufacturer identifier information derived using the message digest algorithm. Access control program 114 generates a second character string by decrypting the access token information using a decryption key. When the first character string is identical to the second character string, the access control program 114 recognizes that the application identifier information, manufacturer identifier information, and access token information of the application program have not been changed. Accordingly, the access control program 114 recognizes the application program as being authorized to access the data stored in the electronic device and functions. Therefore, the access control program 114 authorizes the application to access the data and functions.

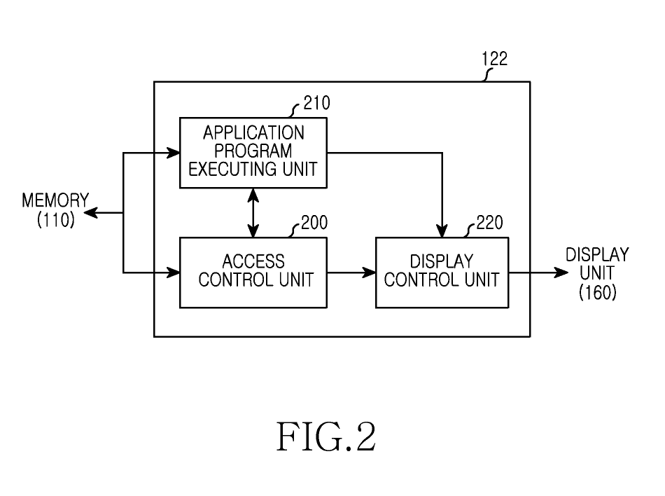

The application program 115 may include a software component for at least one application program installed in the electronic device 100. The processor unit 120 may include a memory interface 121, at least one processor 122, and a peripheral interface 124. Memory interface 121, the at least one processor 122 and the peripheral interface 124 may be integrated into at least one integrated circuit or be implemented as separate components. The memory interface 121 controls access to the memory components. The peripheral interface 124 controls connections of the input/output peripherals to the processor 122 and the memory interface 121. The processor 122 enables the electronic device 100 to provide different services using at least one software program. Processor 122 executes at least one program stored in the memory 110 to provide a service. For example, the processor 122 may be configured as illustrated in FIG. 2 in order to execute the access control program 114 and control data access of an application program.

The audio processing unit 130 provides an audio interface between a user and the electronic device 100 through a speaker 131 and a microphone 132. The communication system 140 may include at least one software component for performing communication functions for voice communication and data communication. In this case, the communication system 140 may comprise a plurality of communication submodules which support different communication networks. For example, the communication networks may include, a GSM (Global System for Mobile Communication) network, an EDGE (Enhanced Data GSM Environment) network, a CDMA (Code Division Multiple Access) network, a W-CDMA (Wideband Division Multiple Access) network, an LTE (Long Term Evolution) network, an OFDMA (Orthogonal Frequency Division Multiple Access) network, a wireless LAN, a Bluetooth network, and NFC (Near Field Communication).

The I/O control unit 150 provides an interface between an input/output device including the display unit 160 and the input device 170, and the peripheral interface 124. The display unit 160 displays status information of the electronic device 100, characters input by the user, moving pictures and still pictures. For example, the display unit 160 displays information about application programs executed by the processor 122. As another example, the display unit 160 may display a message indicating whether it is possible to access data, which is provided from the access control program 114 in response to the control of the GUI program 113. The input device 170 provides input data generated by user command to the processor unit 120 through the input/output control unit 150. The input device 170 may include a keypad including at least one hardware button and a touch pad for detecting touch information. For example, the input device 170 may provide touch information detected through the touch pad to the processor 122 through the input/output control unit 150.

FIG. 2 shows processor 122 that may include an access control unit 200, an application program executing unit 210, and a display control unit 220. The access control unit 200 executes the access control program 114 of the program storage unit 111 to generate access token information in order to control data access of an application program. For example, the access control unit 200 detects the application identifier information and manufacturer identifier information of an application program for enabling access to the data of the electronic device. The application identifier information of the application program distinguishes between respective application programs of a plurality of application programs in the electronic device. Access control unit 200 applies a message digest algorithm to the manufacturer identifier information. In this case, the message digest algorithm generates a fixed length of output character string regardless of the length of an original character string. Access control unit 200 generates one character string by using the identifier information and the manufacturer identifier information derived using the message digest algorithm. Thereafter, the access control unit 200 generates access token information by encrypting the character string using an asymmetric encryption key.

In addition, the access control unit 200 executes the access control program 114 of the program storage unit 111 to control data access of an application program. For example, when at least one application program performs an attempt to access at least a data item (for example, call log, message contents, and Internet bookmark information) stored in the electronic device and functions (for example, message transmission function, telephone function, and network connection function), the access control unit 200 detects the application identifier information, manufacturer identifier information, and access token information of the application program Access control unit 200 applies a message digest algorithm to the manufacturer identifier information and generates a first character string by sequentially joining a character string including the application identifier information and the character string of the manufacturer identifier information derived using the message digest algorithm. Access control unit 200 generates a second character string by decrypting the access token information using a decryption key. When the first character string is identical to the second character string, the access control unit 200 recognizes that the application identifier information, manufacturer identifier information, and access token information of the application program have not been changed. Accordingly, the access control unit 200 recognizes the application program as being authorized to access the data stored in the electronic device and functions. Therefore, the access control unit 200 authorizes the application to access the data and functions.

The display control unit 220 executes the GUI program 113 of the program storage unit 111 to provide a graphic user interface on the display unit 160. For example, the display control unit 220 displays information about an application program executed by the processor 122 on the display unit 160. The display control unit 220 may enable the access control unit 200 to display a message indicating whether it is possible to access the data of the electronic device 100 on the display unit 160. Access control unit 200 of the electronic device executes the access control program 114 to control data access of the application program. Device 100 may include a separate access control module including the access control program 114.

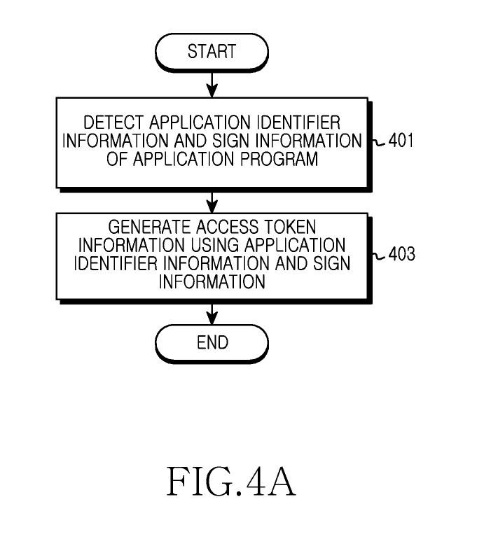

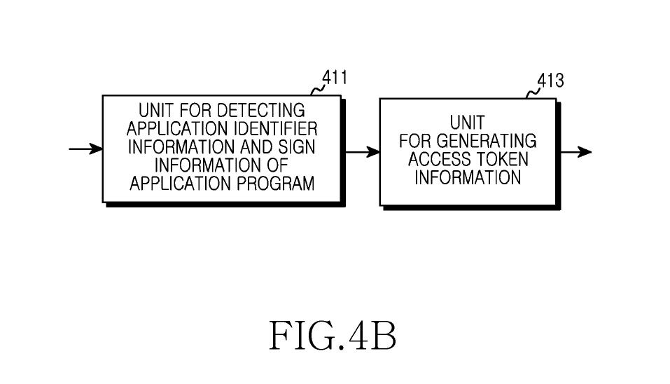

FIG. 4A illustrates a process of generating access token information to control data access of an application program in an electronic device. In operation 401, the electronic device detects the application identifier information and manufacturer identifier information of an application program. In operation 403, the electronic device generates access token information by using the application identifier information and the manufacturer identifier information. In response to detecting the application identifier information and first manufacturer identifier information of the application program, the electronic device generates second manufacturer identifier information by applying a message digest algorithm to the first manufacturer identifier information. In this case, the message digest algorithm generates a fixed length output character string regardless of the length of an original character string. The message digest algorithm may include at least one of MD2 (Message Digest 2), MD4 (Message Digest 4), MD5 (Message Digest 5), SHA (Secure Hash Algorithm), and SHA1 (Secure Hash Algorithm 1). In response to generating the second manufacturer identifier information, the electronic device generates a character string by sequentially joining a character string including the application identifier information and the character string of the second manufacturer identifier information. In response to generating the character string using the application identifier and the second manufacturer identifier information, the electronic device generates a character string by sequentially joining the character string including the application identifier information and the character string of the second manufacturer identifier information. Thereafter, the electronic device generates access token information by encrypting the character string using an asymmetric encryption key and the process terminates.

The processes for generating access token information to control data access of an application program in the electronic device may be implemented using an apparatus for generating access token information to control data access of an application program in the electronic device for generating access token information to control data access of an application program of FIG. 4B. The electronic device may include a first unit 411 for detecting the application identifier information and manufacturer identifier information of an application program and a second unit 413 for generating access token information. The first unit 411 detects the application identifier information and manufacturer identifier information of the application program. The second unit 413 generates access token information by using the application identifier information and the manufacturer identifier information as previously described. After generating the second manufacturer identifier information, the electronic device generates a character string by sequentially appending a character string including the application identifier information and the character string of the second manufacturer identifier information. After generating the character string using the application identifier and the second manufacturer identifier information, the electronic device generates a character string by sequentially appending the character string including the application identifier information and the character string of the second manufacturer identifier information, for example. Alternatively, the strings may be combined in different ways with intervening data or markers, for example. Thereafter, the electronic device generates access token information by encrypting the character string using an asymmetric encryption key.

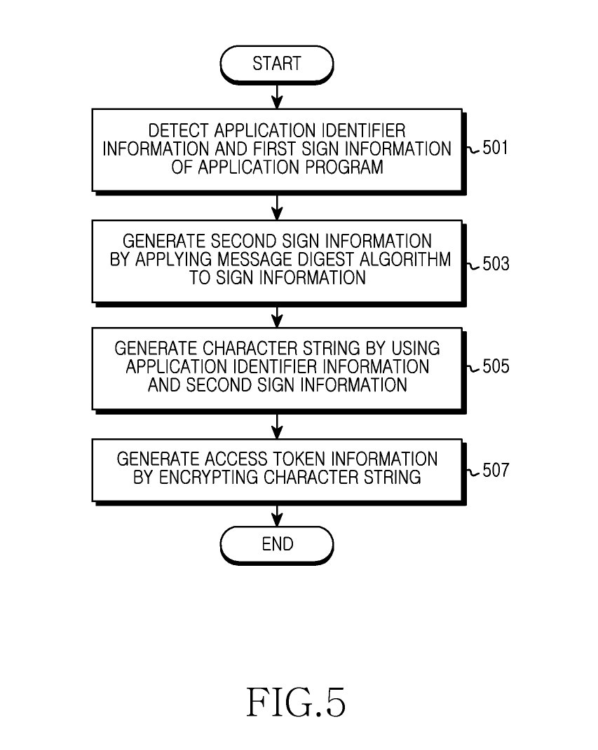

FIG. 5 shows a flowchart of a process for generating access token information to control data access of an application program in an electronic device. In operation 501, the electronic device detects the application identifier information and first manufacturer identifier information of an application program. In response to detecting the application identifier information and first manufacturer identifier information of the application program, the electronic device generates second manufacturer identifier information by applying a message digest algorithm to the first manufacturer identifier information in operation 503 as previously described. In response to generating the second manufacturer identifier information, the electronic device generates a character string using the application identifier information and the second manufacturer identifier information in operation 505. For example, the electronic device may generate the character string by sequentially appending the character string including the application identifier information and the character string of the second manufacturer identifier information. In response to generating the character string using the application identifier information and the second manufacturer identifier information, the electronic device generates access token information by encrypting the character string in operation 507 using an asymmetric encryption key as previously described and the process ends.

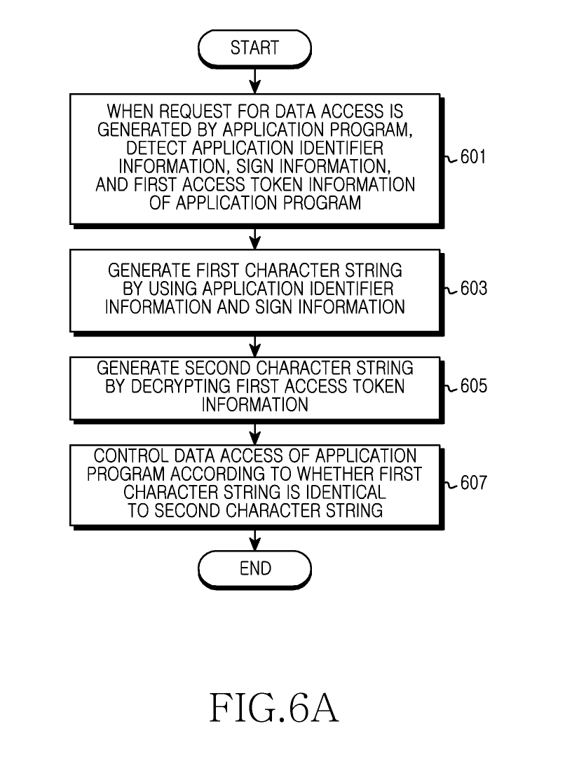

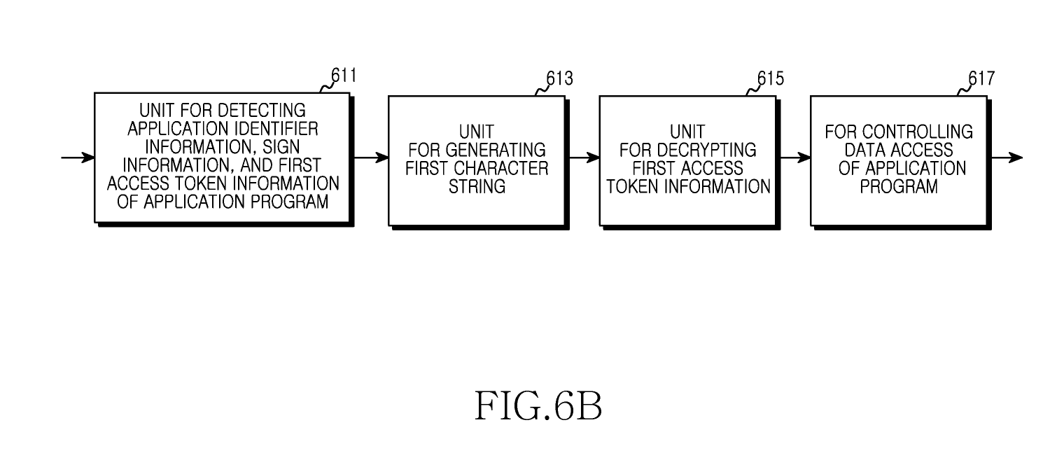

FIG. 6A shows a flowchart of a process for controlling data access to an application program in an electronic device where, when a request for data access is generated by an application program in operation 601, the electronic device detects the application identifier information, manufacturer identifier information, and first access token information of the application program. For example, when at least one application program performs an attempt to access at least one of data item (for example, call log, message contents, and Internet bookmark information) stored in the electronic device and functions (for example, message transmission function, telephone function, and network connection function), the electronic device detects the application identifier information, manufacturer identifier information, and first access token information of the application program In addition, when the first access token information does not exist in operation 601, the electronic device may recognize the application program as not authorized to access the data stored in the electronic device and functions, and end the process. In operation 603, the electronic device generates a first character string by using the application identifier information and the manufacturer identifier information. The electronic device may generate the first character string by sequentially appending a character string including the application identifier information and the character string of the manufacturer identifier information derived using a message digest algorithm. In operation 605, the electronic device generates a second character string by decrypting the first access token information using a decryption key.

In operation 607, the electronic device controls the data access of the application program in response to whether the first character string is identical to the second character string. For example, when the first character string is identical to the second character string, the electronic device recognizes that the application identifier information, manufacturer identifier information, and first access token information of the application program have not been changed. That is, the electronic device recognizes the application program as being authorized to access the stored data and functions of the electronic device. Therefore, the electronic device authorizes the application program to access the data and functions. In addition, when the first character string is not identical to the second character string, the electronic device recognizes that at least one of the application identifier information, first manufacturer identifier information, and first access token information of the application program are changed. Therefore, the electronic device recognizes the application program is not authorized to access the stored data and functions of the electronic device and rejects the request for data access of the application program and the electronic device ends the process.

FIG. 6B shows an electronic device for controlling data access of an application program including first unit 611 for detecting the application identifier information, manufacturer identifier information, and first access token information of an application program, a second unit 613 for generate a first character string, a third unit 615 for encrypting the first access token information, and a fourth unit 617 for controlling data access of the application program. In response to a request for data access being generated by an application program, the first unit 611 detects the application identifier information, manufacturer identifier information, and first access token information of the application program. For example, when at least one application program performs an attempt to access at least one data item (such as, call log, message contents, and Internet bookmark information) stored in the electronic device and functions (for example, message transmission function, telephone function, and network connection function), the electronic device detects the application identifier information, manufacturer identifier information, and first access token information of the application program In addition, when the first access token information does not exist in operation 601, the electronic device may recognize the application program as not being authorized to access the data stored in the electronic device and functions, and end the algorithm.

The second unit 613 generates a first character string by using the application identifier information and the manufacturer identifier information as previously described. The third unit 615 generates a second character string by decrypting the first access token information. For example, the electronic device generates the second character string by decrypting the first access token information using a decryption key. The fourth unit 617 controls the data access to an application program in response to whether the first character string is identical to the second character string and the electronic device ends the algorithm.

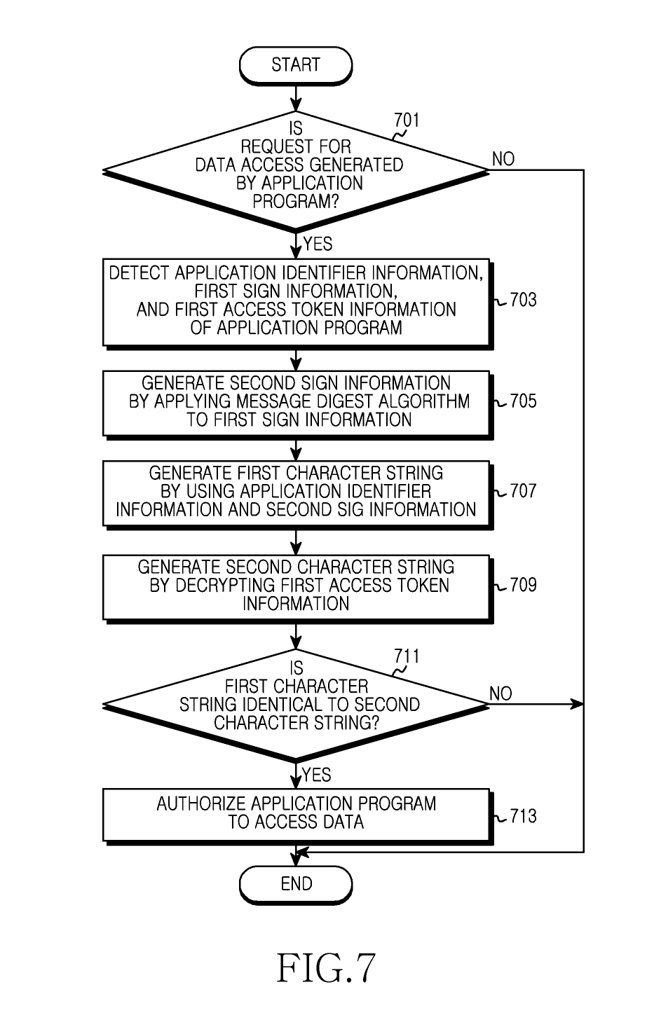

FIG. 7 shows a flowchart of a process for controlling data access to an application program in an electronic device. In operation 701, the electronic device determines whether a request for data access is generated by an application program. For example, the electronic device determines whether an application program performs an attempt to access a stored data item and if a request for data access is not generated, the electronic device ends the process. If a request for data access is generated by the application program, the electronic device detects the application identifier information, first manufacturer identifier information, and first access token information of the application program in operation 703. In addition, when the first access token information does not exist in operation 703, the electronic device may recognize the application program as not being authorized to access the data stored in the electronic device and functions, and end the process.

The electronic device generates second manufacturer identifier information by applying a message digest algorithm to the first manufacturer identifier information in operation 705 as previously described. In response to generating the second manufacturer identifier information, the electronic device generates a first character string by using the application identifier information and the second manufacturer identifier information in operation 707. In operation 709, the electronic device generates a second character string by decrypting the first access token information using a decryption key. In operation 711, the electronic device determines whether the first character string is identical to the second character string. When the first character string is not identical to the second character string, the electronic device recognizes the application program is not authorized to access the stored data and functions in the electronic device, and ends the process. If the first character string is identical to the second character string, the electronic device authorizes the application program to access the data and functions in operation 713.

The electronic device applies a message digest algorithm to the sign information of the application program to generate access token information. In another embodiment, the electronic device may generate access token information by using the application identifier information and manufacturer identifier information of an application program. As another example, when the manufacturer identifier information of the application program is a character string that is equal to or longer than a predetermined length, the electronic device may apply the message digest algorithm to the manufacturer identifier information.

The system can be realized in the form of hardware, software or a combination of hardware and software stored in a non-transient computer readable storage medium. The non-transient computer readable storage medium stores one or more programs (software modules) comprising instructions, which when executed by one or more processors in an electronic device, cause the electronic device to perform a method of the present disclosure. Any such software may be stored in the form of volatile or non-volatile storage. The above-described embodiments can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. The functions and process steps herein may be performed automatically or wholly or partially in response to user command. An activity (including a step) performed automatically is performed in response to executable instruction or device operation without user direct initiation of the activity. No claim element herein is to be construed under the provisions of 35 U.S.C. 112, sixth paragraph, unless the element is expressly recited using the phrase “means for.” Programs may be conveyed electronically via a medium such as a communication signal carried over a wired or wireless connection and embodiments suitably encompass the same.

While the system has been shown and described with reference to certain exemplary embodiments thereof, it will be understood by those skilled in the art that various changes in form and details may be made therein.

What is claimed is:

1. A method for determining access authorization to data in an electronic device, comprising:
detecting application identifier information of an application program;
detecting manufacturer identifier information of the application program; and
generating access token information using the application identifier information of the application program and the manufacturer identifier information.

2. The method of claim 1, further comprising applying a message digest process to the manufacturer identifier information in response to detection of the application identifier information of the application program and the manufacturer identifier information to derive the access token information.

3. The method of claim 2, further comprising generating access token information using the application identifier information of the application program and the manufacturer identifier information derived using the message digest process.

4. The method of claim 1, further comprising generating a character string by sequentially appending the application identifier information of the application program and the manufacturer identifier information in response to detection of the application identifier information of the application program and the manufacturer identifier information.

5. The method of claim 4, further comprising generating access token information by encrypting the character string.

6. The method of claim 5, wherein generating the access token information comprises encrypting the character string using an asymmetric encryption key.

7. The method of claim 1, further comprising packaging the application program including the application identifier information, the manufacturer identifier information and the access token information.

8. A method for controlling access to data in an electronic device, comprising:
in response to generation of a request for data access by an application program, detecting application identifier information of the application program, manufacturer identifier information, and first access token information;
generating a first character string using the application identifier information of the application program and the manufacturer identifier information;
generating a second character string by decrypting the first access token information; and
in response to a determination the first character string is identical to the second character string, authorizing the application program to access data.

9. The method of claim 8, further comprising applying a message digest algorithm to the manufacturer identifier information in response to detection of the application identifier information of the application program, the manufacturer identifier information, and the first access token information.

10. The method of claim 9, further comprising generating the first character string using the application identifier information of the application program and the manufacturer identifier information derived using a message digest algorithm.

11. The method of claim 8, wherein generating the second character string comprises decrypting the first access token information using an asymmetric decryption key.

12. An electronic device, comprising:
at least one processor;
at least one memory; and
at least one program stored in the memory and configured to be executable by the processor,
wherein the processor:
detects application identifier information of an application program and manufacturer identifier information; and
generates access token information using application identifier information of the application program and the manufacturer identifier information.

13. The electronic device of claim 12, wherein the processor applies a message digest algorithm to the manufacturer identifier information.

14. The electronic device of claim 13, wherein the processor generates the access token information using the application identifier information of the application program and the manufacturer identifier information derived using the message digest algorithm.

15. The electronic device of claim 12, wherein the processor generates a character string using the application identifier information of the application program and the manufacturer identifier information.

16. The electronic device of claim 15, wherein the processor generates the access token information by encrypting the character string.

17. The electronic device of claim 16, wherein the processor encrypts the character string using an asymmetric encryption key.

18. The electronic device of claim 12, wherein the processor packages the application program including the application identifier information, the manufacturer identifier information and the access token information.

19. An electronic device, comprising:
at least one processor;
at least one memory; and
at least one program stored in the memory and configured to be executable by the processor,
wherein the processor:
in response to a request for data access being generated by an application program, detects application identifier information of the application program, manufacturer identifier information, and first access token information;
generates a first character string using the application identifier information of the application program and the manufacturer identifier information;
generates a second character string by decrypting the first access token information; and
in response to the first character string being identical to the second character string, authorizing the application program to access data.

20. The electronic device of claim 19, wherein the processor applies a message digest algorithm to the manufacturer identifier information.

21. The electronic device of claim 20, wherein the processor generates the first character string using the application identifier information of the application program and the manufacturer identifier information derived using the message digest algorithm.

22. The electronic device of claim 21, wherein the processor decrypts the first access token information using an asymmetric encryption key.
